(19) United States
(12) Patent Application Publication
(10) Pub. No.: US 2009/0051160 A1
(43) Pub. Date: Feb. 26, 2009

(54) BONDING SOCKET FOR HIGH PRESSURE MEDICAL HOSE

(75) Inventor: Rowland W. Kanner, Guntersville, AL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: ATRION MEDICAL PRODUCTS, INC., Arab, AL (US)

(21) Appl. No.: 12/141,977

(22) Filed: Jun. 19, 2008

Related U.S. Application Data
(60) Provisional application No. 60/956,729, filed on Aug. 20, 2007.

(51) Int. Cl. F16L 35/00

(52) U.S. Cl. 285/24

(57) ABSTRACT

A socket for receiving a medical hose or tubing. The hose may be, for example, reinforced medical hose. The socket includes an internal conical feature which enters an end of the hose when the hose is inserted in the socket. The conical feature compresses the hose, and places the hose wall under radial compression, which tends to keep the hose retained in the socket, even during a high pressure application The compression creates a barrier seal between the hose lumen and the conical feature to prevent fluid from contacting the very end of the hose. As such, there is less longitudinal force attempting to push the hose out of the socket. If a reinforced hose is used, the compression places the jacket bond line and each fiber under compression in order to raise resistance to pressurized fluid entry, should the barrier seal be breached

### RELATED APPLICATION (PRIORITY CLAIM)

This application claims the benefit of U.S. Provisional Application Ser. No. 60/956,729, filed Aug. 20, 2007, which is hereby incorporated by reference in its entirety.

### BACKGROUND

The present invention generally relates to sockets for bonding medical hoses, and more specifically relates to a socket configuration for bonding a small diameter medical hose for use in a high pressure application.

High pressure medical hose (i.e., tubing) is generally made by extruding a first tube form, known as an inner jacket, from an elastomeric resin. Once formed and cooled sufficiently to be self-supporting, this tube form is then wrapped with a reinforcing fiber braid of monofilament fibers. Subsequently, the fiber-wrapped assembly is drawn through a cross die extrusion head which extrudes an outer jacket to the assembly, encapsulating the reinforcement fibers between the jacket layers (i.e., between the inner jacket and the outer jacket). If all goes well, the molten outer jacket material bonds to the inner jacket surface and, to some degree, the reinforcing fibers. However, these bonds are never as strong as the parent materials involved. Since the reinforcing fibers are of different material than the jacket material, the bond between the reinforcement fibers and the outer jacket is weaker than the bond between the inner jacket and the outer jacket. Manufacturers of high pressure reinforced medical hoses constantly struggle to produce a hose which has bonds of sufficient strength to resist high pressure failure modes.

Due to low stiffness of the resin used, the resulting hose is generally quite flexible which suits the conditions under which the hose is to be used. A rather open spacing between the reinforcing fibers of the finished assembly facilitates flexibility while imparting extraordinary tensile and pressure-resisting strength. Due to a reinforcement braid, hoses used on angioplasty inflation devices for example, are capable of withstanding applied internal operating pressures of 1,700 p.s.i. or more before bursting.

These hoses can be fairly small, having an outer diameter of 0.140 inches and a lumen of less than 0.070 inches. They are most often used on disposable medical devices made of plastic. The pressure-generating medical devices on which these hoses are used must be sufficiently robust in order to withstand high pressures and rough handling. Due to the fact that these hoses have very small passageways, attaching the hose by means of a traditional hose barb form is not practical. Such hose barbs would need to be extraordinarily thin-walled to minimize fluid flow restrictions, rendering them weak and fragile. Therefore, as shown in FIG. 1, hoses of this type are typically inserted and bonded into a receiving bore or socket 10 of the pressure device 12. Either solvents or adhesives are utilized to bond the hose to the socket, with solvents being used more often due to the fact that they are easier to apply and handle than adhesives.

When reinforced elastomeric hoses of the type described hereinabove are bonded into receiving sockets of a device, they are prone to suffer from two weaknesses directly attributable to their manufacturing process and overall structure. These weaknesses are aggravated by the traditional hose socket configuration. Specifically, working fluid under pressure within the functioning device can enter locations at the end of the hose where the reinforced fibers provide conduits. If the fibers are not bonded well to the outer jacket, the pressurized fluid begins to bleed along the fibers, and separate the outer jacket from the fibers. The structure of the hose is such that the reinforcing fibers cross one another. As such, their encapsulations at each intersection offer numerous additional conduits for the pressurized fluid. As more fibers become involved in this destructive process, the pressurized fluid begins to inflate the space between the fibers and the jackets until eventually the bond between the inner and the outer jacket fails, and the outer jacket either separates from the inner jacket or it ruptures. Hose failures of this type rob essential working pressure from the medical device and can compromise sterility of the medical procedure as well as destroy the potency of the device.

### OBJECTS AND SUMMARY

An object of an embodiment of the present invention is to provide an improved medical hose socket, such as for use in high pressure applications.

Briefly, an embodiment of the present invention provides a socket, such as on a medical device for receiving an elastomeric hose or tubing. The hose may be, for example, reinforced medical hose. The socket includes an internal conical feature which is configured to enter an end of the hose when the hose is inserted in the socket. The socket's conical feature compresses the hose and places the hose wall under radial compression, which seals the junction against leakage and increases compression of the hose wall elastomer against its encapsulated reinforcing fiber to prevent introduction of medical fluid along the fiber's path.

### BRIEF DESCRIPTION OF THE DRAWINGS

The organization and manner of the structure and operation of the invention, together with further objects and advantages thereof, may best be understood by reference to the following description, taken in connection with the accompanying drawing, wherein:

FIG. 1 is an enlarged cross-sectional view of a prior art medical hose socket;

FIG. 2 is an enlarged cross-sectional view of a medical hose socket which is in accordance with an embodiment of the present invention;

FIG. 3 is similar to FIG. 2, but shows a medical hose engaged in the socket;

FIG. 4 shows an enlarged perspective view of the device which includes the socket shown in FIGS. 3 and 4;

FIG. 5 is an enlarged cross-sectional view of the device shown in FIG. 4;

FIG. 6 is an enlarged cross-sectional view of the socket gripping and compressing a hose;

FIG. 7 is an enlarged perspective view of the cylindrical extending portion which provides the socket therein;

FIG. 8 illustrates the results of some experiments that were conducted with thirty hoses, and is a chart which compares pressure decay for each hose installed on a prior art socket such as shown in FIG. 1 to pressure decay for the hose installed on a socket as shown in FIG. 2.

### DESCRIPTION

While the invention may be susceptible to embodiment in different forms, there is shown in the drawings, and herein will be described in detail, a specific embodiment of the invention. The present disclosure is to be considered an example of the principles of the invention, and is not intended to limit the invention to that which is illustrated and described herein.

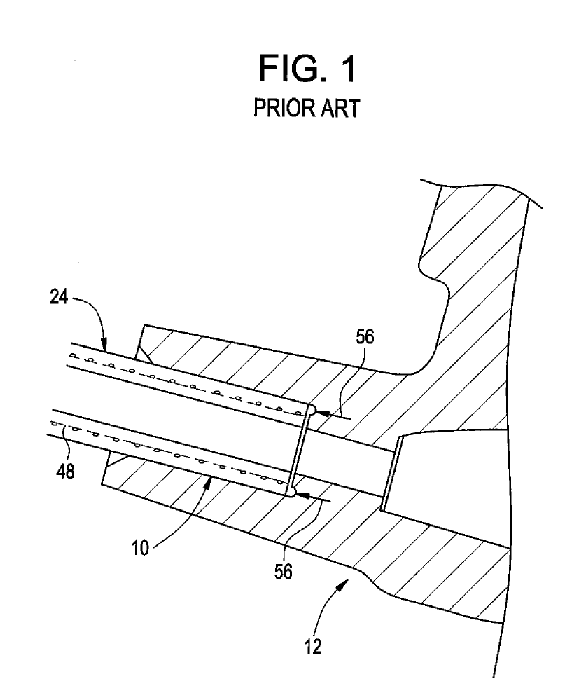

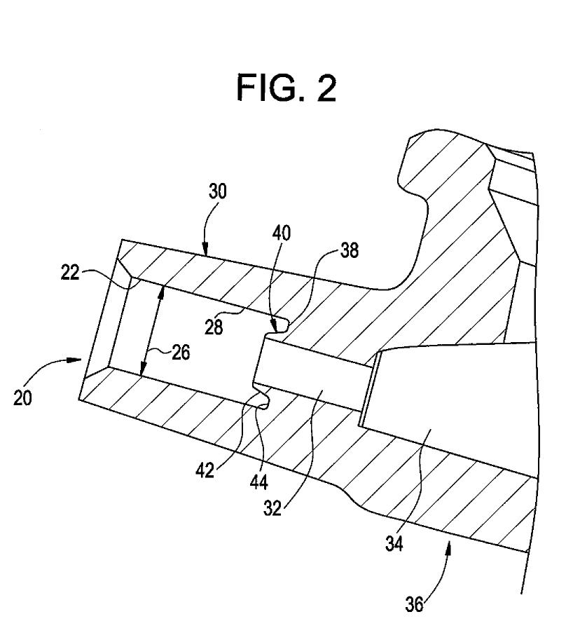

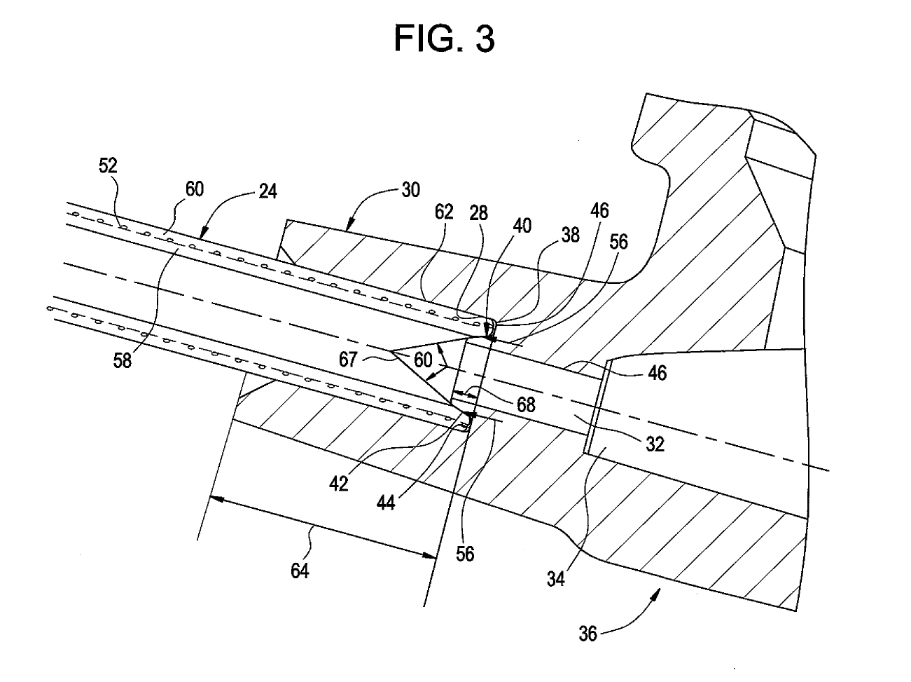

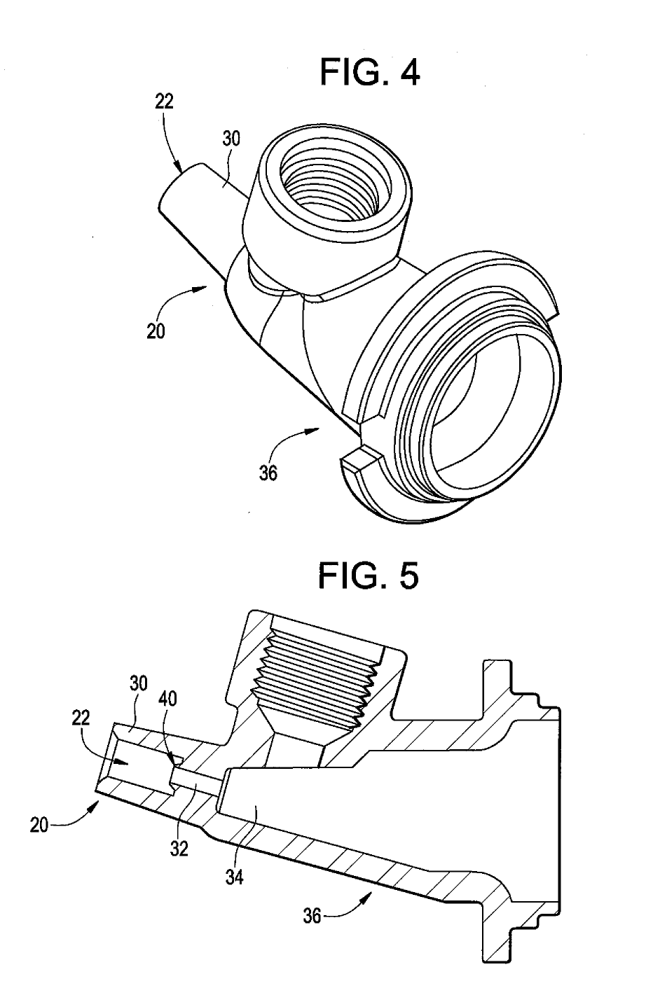

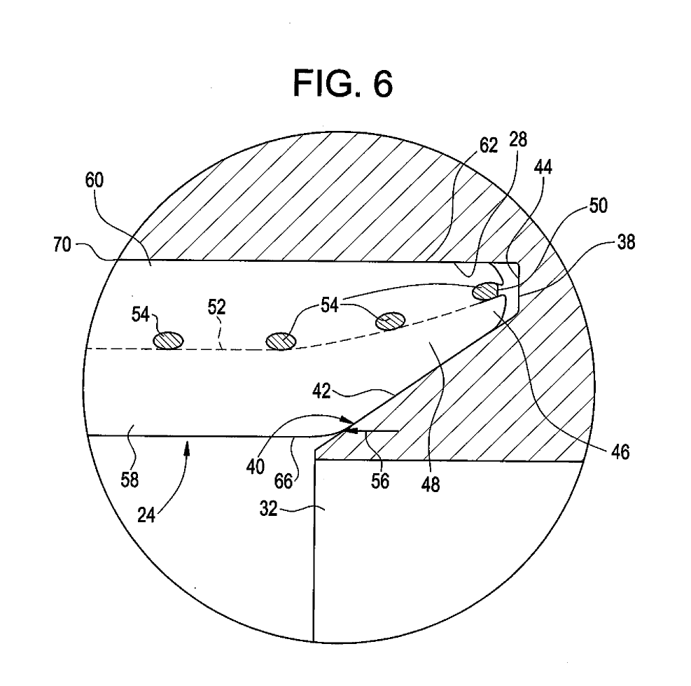

FIG. 2 illustrates, in cross-section, a specific embodiment of the present invention. Specifically, FIG. 2 illustrates a medical hose socket 20, such as for use in high pressure applications. As shown, much like the hose socket 10 shown in FIG. 1, the hose socket 20 shown in FIG. 2 includes an opening 22 for receiving a medical hose 24 (See FIGS. 3 and 6). The medical hose 24 may or may not be a hose which consists of reinforcement fibers encapsulated between two jackets as described hereinabove. Regardless, as will be discussed in more detail below, if a solvent is used to connect the hose 24 to the socket 20, preferably the opening 22 provides an inner diameter (i.e., dimension 26 in FIG. 2) that assures a small amount of interference fit with the hose 24 it is to receive (see FIGS. 3 and 6). On the other hand, if an adhesive is used, preferably a slight clearance is provided between the hose 24 and an internal sidewall 28 to provide space for adhesive to reside.

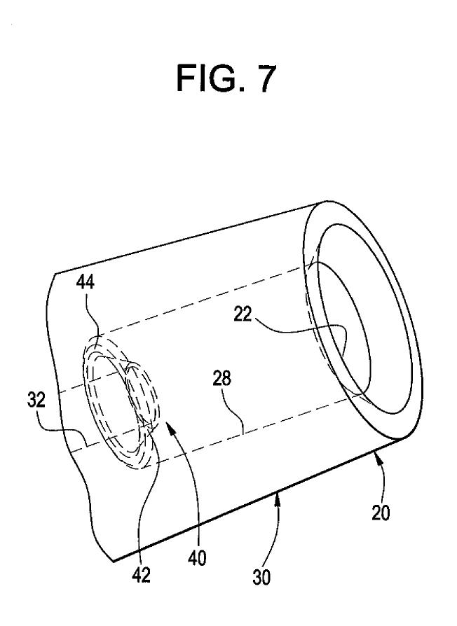

The opening 22 into the socket 20 is provided on a cylindrical extending portion 30, and inside the socket 20 is a conduit 32 which leads to an internal area 34, thereby providing a fluid passageway into the device 36. At the base 38 of the socket 20 is a conical feature or cone 40 (see FIGS. 2, 3, 5, 6 and 7). The conical feature 40 includes an angled wall 42 proximate the conduit 32. Specifically, inside the cylindrical portion 30 is a longitudinal internal sidewall 28 which ends at a ninety degree angle at a base wall 44 in the socket 20. The base wall 44 intersects the angled wall 42, and the angled wall 42 effectively provides the conical feature 40.

The conical feature 40 in the socket 20 is not a barb, and it functions quite differently. As shown in FIGS. 3 and 6, the conical feature 40 is configured to enter the end 46 of an inserted hose 24 during the assembly process. As shown, the conical feature 40 serves to compress the hose end 46, thereby placing the hose wall 48 under radial compression. This compression initially utilizes the elastomeric properties of the hose 24 to create a barrier seal between the hose lumen and the conical feature 40 to prevent fluid from reaching reinforcement fiber ends 50 (assuming such a hose 24 is used). In either instance, whether solvent or adhesive bonding is utilized to retain the hose, the space between sidewall 28 of socket 20 and conical feature 40 must be formed such that the smallest end of conical feature 40 is slightly less than the hose lumen in order to allow it to enter the hose and compress the hose wall 48 against sidewall 28 whenever the hose is pressed fully into socket 20. As shown in FIG. 6, compression of the hose wall 48 places the jacket bond line or knit line 52, and subsequently each encapsulated fiber 54 under compression in order to raise resistance to pressurized fluid entry, should the first barrier be breached. An additional benefit of the high pressure socket configuration is that, even if a non-reinforced hose is used (i.e., a hose not having internal reinforcing braids), there is less longitudinal force attempting to push the hose out of the socket 20 during pressurization (i.e., in the direction indicated with arrows 56 in FIGS. 3 and 6). A reduction in force is due to the fact that the cross-sectional area upon which pressure is exerted against the hose 24 is established by an area bordered by intersection of the hose lumen and cone (A1), and this area is always smaller than the cross-sectional area of the entire hose (A2). As such, the longitudinal pressure against the hose is reduced in direct proportion to the two areas ((A1/A2)×system pressure).

The increased retention ability of the socket shown in FIG. 2 compared to the socket shown in FIG. 1 results from there being less cross-sectional surface area exposed to pressure in the socket combined with a shear resisting connection between the outer hose wall 48 and the socket sidewall 28. This could be solvent based, adhesive based, or even mechanical. While it is true that pressure tending to expand the hose drives the hose wall more solidly into contact with the socket sidewall as long as the seal between the hose lumen and the cone is established during assembly by initial assembly pressure, a separate retaining mechanism to secure the hose wall to the socket wall is still required. Nevertheless, internal expansion due to operational pressures within a device will provide additional retention assistance and compress the elastomeric hose material into more intimate contact with the reinforcing fiber. Experimentation has shown that high internal system pressures will in fact compress the elastomer against the socket wall and prevent flow along reinforcing fibers but for this to happen, a pressure differential must first be created along the fiber's path and that differential depends upon a good initial seal at the cone to prevent fluid loss at pressures below those capable of compressing the hose elastomer tightly against the socket wall. It should be appreciated that compressing pressure will vary with durometer of the hose elastomer.

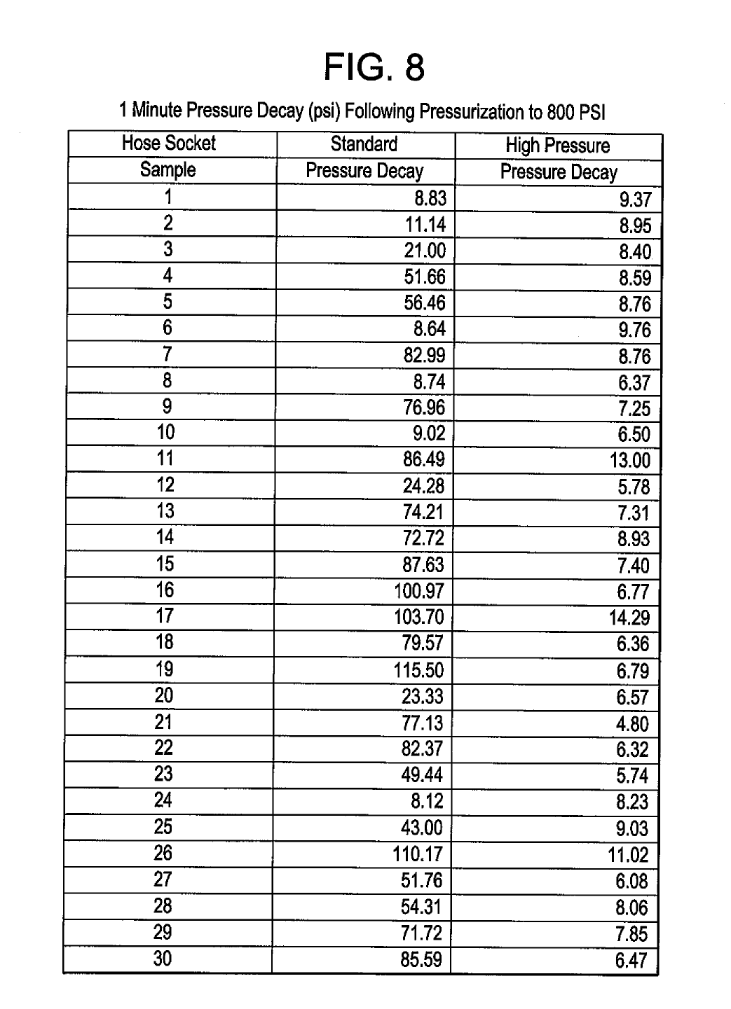

Experiments were conducted to compare pressure loss (decay) performance utilizing a high pressure socket configuration 20 which is in accordance with an embodiment of the present invention (i.e., FIG. 2) upon hoses that had previously delaminated under testing with standard hose sockets 10 (i.e., FIG. 1). The results were impressive as can be seen by viewing the chart shown in FIG. 8 and comparing pressure decay values from 800 p.s.i. for hoses that were bonded to a standard hose socket (i.e., FIG. 1) and decay tested and subsequently bonded to the high pressure socket (i.e., FIG. 2) and retested. In one instance (“Hose Socket Sample 19” in FIG. 8), the same hose that demonstrated 115.50 p.s.i. pressure loss from flow along the reinforcing fiber when bonded to a standard hose socket (i.e., FIG. 1) lost only 6.69 p.s.i. due only to expansion when bonded to the high pressure socket (i.e., FIG. 2).

Assuming the socket 20 shown in FIG. 2 is used with a high pressure reinforced medical hose as described in detail hereinabove (i.e., having an inner jacket 58, an outer jacket 60, and reinforcing braids 54 encapsulated therebetween as shown in FIG. 6), the hose 24 is either dipped into or has applied to its end either a solvent or adhesive that is mutually appropriate for the hose material and the device to which the hose will be bonded. Solvent or to adhesive is preferably applied to the outer jacket surface 62 for a length along the jacket 60 that is equal to the depth of the hose socket into which the hose 24 will be introduced (i.e., length 64 shown in FIG. 3). Hoses treated with solvent are simply pressed firmly into the socket, thereby compressing the compliant hose slightly to assure intimate contact and fusion between socket and hose materials. Pressing the hose 24 firmly in place also allows the conical feature 40 to enter the hose lumen 66 and compress the hose wall 48 between the angled wall 42 and sidewall 28, as insertion force is applied. Friction between the internal sidewall 28 of the socket 20 and the hose exterior 62 serves to hold an inserted hose in place until solvent has fused both pieces together. When adhesives are used to bond the hose to the socket, slight clearance between both parts is required to provide space for adhesive to reside. Therefore, fixturing is required when using adhesive to maintain hose compression against the conical feature until the bond has set. In either case, it is not necessary to apply any solvent or adhesive to hose surfaces that contact the cone. Compression alone is sufficient for the assembly to function as intended.

Female sockets for medical hoses are sized to provide either an interference fit with a hose or clearance relative to the hose as previously described, based upon one's chosen bonding method. Depth of a hose socket for solvent bonding is preferably equal to at least two hose diameters and it may be as much as three. When solvent bonding, assembly interference and a given solvent's flash and diffusion rates place practical limits on socket depth.

In the high pressure hose socket described hereinabove, the included angle (identified with reference numeral 67 in FIG. 3) of the cone can vary; however, practical design and manufacturing considerations must be considered since cones rob usefull bonding length from sockets. Ideally the cone should be as short as is practical (i.e., dimension 68 in FIG. 3) in order to keep hose socket depths to a reasonable level. Cones having low included angles will be longer, thus demanding longer hose sockets. Experiments have shown that cones having approximately 60 degrees of included angle perform well and are reasonably short. Sealing force within this high pressure hose socket results from a combination of applied longitudinal force during hose insertion, circumferential tension generated as the hose stretches over the cone and radial compressive force resulting from the hose wall being compressed in the narrowing space between the cone and the internal wall of the socket.

If the included cone angle were 180 degrees (essentially a flat surface like the base wall 44), only longitudinal compression force would be available to seal. In such a case, no circumferential tension or radial compressive force could be relied upon to assist sealing. With a 180 degree cone, the compression force would need to exceed a calculated value equal to the cross-sectional area of the inner jacket multiplied by the fluid pressure. With cone angles smaller than 180 degrees, the hose expands around the cone as both are pressed together and the circumferential tensile strength of the hose contributes to sealing as does the radial compression force which is generated between the converging walls of the cone and the internal wall of the socket. Therefore, lower cone angles facilitate transition away from a seal reliant upon pure longitudinal compression to one derived from a combination of circumferential tension and radial compression. The net effect of these additional sealing force factors is to reduce the longitudinal compression force required to perfect a seal as cone angles are reduced. Because the amount of longitudinal compression force one must apply to achieve a seal decreases with decreased cone angles, it is believed that cones having greater than a 95 degree included angle would prove less efficient in terms of utilizing longitudinal input forces. This limitation is impacted by the hardness (durometer) of the hose material, its frictional properties against the cone material, and its circumferential strength.

Due to the elastic memory of hose materials, an additional consideration regarding large cone angles is that the force applied to achieve compression against the cone for sealing purposes results in shear at the hose to socket bond line (identified with reference numeral 70 in FIG. 6) as the compressed hose 24 attempts to push itself back off a high included angle cone and out of its socket. Reduced cone angles help convert longitudinal installation force into circumferential hose expansion, hose wall compression and friction against the contacting surfaces. With lower cone angles, grip between contact surfaces created by this friction tends to retain the installed hose in place therefore reducing shear force at the bond line.

The specific embodiment described hereinabove provides many advantages some of which have been described hereinabove. While an embodiment of the present invention is shown and described, it is envisioned that those skilled in the art may devise various modifications of the present invention without departing from the spirit and scope of the present invention.

What is claimed is:

1. A socket on a medical device for receiving a hose, said socket comprising an internal conical feature which is configured to enter an end of the hose when the hose is inserted in the socket, whereby the conical feature compresses the hose, and places the hose wall under radial compression.

2. A socket as recited in claim 1, wherein the socket comprises an opening for receiving the hose.

3. A socket as recited in claim 1, wherein the socket comprises a cylindrical extending portion, and an opening provided at an end of the cylindrical extending portion for receiving the hose.

4. A socket as recited in claim 1, wherein the socket comprises a conduit which leads to an internal area, thereby providing a fluid passageway.

5. A socket as recited in claim 4, wherein the conical feature comprises an angled wall which is proximate the conduit.

6. A socket as recited in claim 3, further comprising a longitudinal internal sidewall which meets a base wall, wherein the base wall meets an angled wall, and the angled wall provides the conical feature.

7. A socket as recited in claim 3, wherein the socket is configured to compress and grip the hose between the angled wall and the longitudinal internal sidewall.

8. A socket as recited in claim 7, wherein the conical feature is configured to enter an end of the hose when the hose is inserted in the socket, wherein the conical feature is configured to compresses the hose against the longitudinal internal sidewall, and place the hose under radial compression.

9. A socket as recited in claim 8, wherein compression of the hose creates a barrier seal between the hose lumen and the conical feature to prevent fluid from contacting the end of the hose.

10. A socket as recited in claim 1, wherein the conical feature provides a sixty degree included angle.

11. A socket as recited in claim 1, wherein the conical feature provides an included angle which is not greater than ninety-five degrees.

12. A socket as recited in claim 1, wherein the socket comprises a cylindrical extending portion, and an opening provided at an end of the cylindrical extending portion for receiving the hose, wherein the socket comprises a conduit which leads to an internal area, thereby providing a fluid passageway, wherein the conical feature comprises an angled wall which is proximate the conduit, further comprising a longitudinal internal sidewall which ends at a base wall, wherein the base wall intersects an angled wall, and the angled wall provides the conical feature.

13. A socket as recited in claim 12, wherein the socket is configured to compress and grip the hose between the angled wall and the longitudinal internal sidewall.

14. A socket as recited in claim 13, wherein the conical feature is configured to enter an end of the hose when the hose is inserted in the socket, wherein the conical feature is configured to compresses the hose against the longitudinal internal sidewall, and place the hose under radial compression, which tends to keep the hose retained in the socket, even during a high pressure application.

15. A socket as recited in claim 14, wherein compression of the hose creates a barrier seal between the hose lumen and the conical feature to prevent fluid from contacting the end of the hose.

16. A socket as recited in claim 12, wherein the conical feature provides an included angle which is not greater than ninety-five degrees.

17. A socket as recited in claim 1, wherein pressure tending to expand the hose drives the hose wall more solidly into contact with the socket sidewall as long as the seal between the hose lumen and the cone is established during assembly by initial assembly pressure, wherein internal expansion due to operational pressures within the device provides additional retention assistance and compresses the hose into more intimate contact with reinforcing fiber of the hose, wherein high internal system pressures compress the hose against the socket wall and prevent flow along reinforcing fibers of the hose, wherein there is a good initial seal at the conical feature to prevent fluid loss at pressures below those capable of compressing the hose tightly against the socket sidewall.

18. A socket for receiving a hose, said socket having an internal conical feature at one end whereby the conical feature is configured to enter the end of an inserted hose and compress the hose against the socket's adjacent sidewall to create a fluid tight seal when the hose is restrained against longitudinal displacement away from the conical feature by means of a shear resisting connection between the outer hose wall and the surrounding sidewall of the socket.

19. A socket for receiving a small fiber elastomeric hose, said socket having an internal conical feature at one end which is configured to enter an end of the hose when the hose is inserted into the socket, whereby the conical feature directs the hose wall elastomer into a receiving space of decreasing volume, thereby compressing the hose wall tighter around the encapsulated reinforcement fiber to prevent fluid leakage along the fiber's path.
